(19) United States
(12) Patent Application Publication
(10) Pub. No.: US 2008/0205423 A1
(43) Pub. Date: Aug. 28, 2008

(54) Method and Apparatus for Communicating Variable-Sized Packets in a Communications Network

(76) Inventor: James J. Gainer, Keller, TX (US)

Correspondence Address: DAVIS & ASSOCIATES, P.O. BOX 1093, DRIPPING SPRINGS, TX, 78620, US

(21) Appl. No.: 11/680,623

(22) Filed: Feb. 28, 2007

(51) Int. Cl. H04L 12/56

(52) U.S. Cl. 370/412; 370/465

(57) ABSTRACT

Methods and apparatus for managing a packet buffer memory are disclosed. One method includes providing a memory arranged as a plurality of cells identified by cell id, each cell having a granularity of k individual memory addresses. A cell list indexed by cell id is provided. The cell list includes a free cell list identifying cells available for storing data as a linked list, wherein a beginning of the free cell list identifies a starting cell id. A cell list indexed by cell id is provided. The free cell list includes cells available for storing data as a linked list, wherein a beginning of the free cell list identifies a starting cell id. Each portion of a packet is stored in cells indicated by and in a sequence indicated by traversing the cell list beginning with the starting cell id.

### TECHNICAL FIELD

This invention relates to the field of communications. In particular, this invention is drawn to methods and apparatus for storing and retrieving packetized data.

### BACKGROUND

Network devices such as switches communicate packets of data between networks. The switch receives packets from any number of input ports and channels the packets to an output port to facilitate communication of the packet to its intended destination. The switch determines the appropriate output port by analyzing information contained within the packets.

A switch must inherently be capable of storing the packets of data, analyzing them, and then communicating them to the appropriate output port. An efficient storage and retrieval architecture is needed because the speed with which the switch can store, process, and communicate packets is critical to network performance.

One architecture relies upon fixed-size memory allocations for storing packets. The allocations are designed to accommodate the largest packet expected for the network. The average packet size, however, might be half of the maximum packet size thus leading to a wasteful allocation of expensive, high-speed memory.

A first-in-first-out architecture might facilitate high-speed handling but inhibits random retrieval. Without the ability to randomly retrieve packets the switch is incapable of prioritizing data flows to support different classes of service.

A more sophisticated architecture may be used to manage memory utilization to ensure that only the memory needed is actually used. Such an architecture, however, tends to require sophisticated memory management overhead and processor resources that become significant limiting factors for increases in data rates.

### SUMMARY

One method of storing a packet includes providing a memory arranged as a plurality of cells identified by cell id, each cell having a granularity of k individual memory addresses. A cell list indexed by cell id is provided. The cell list includes a free cell list identifying cells available for storing data as a linked list, wherein a beginning of the free cell list identifies a starting cell id. A cell list indexed by cell id is provided. The free cell list includes cells available for storing data as a linked list, wherein a beginning of the free cell list identifies a starting cell id. Each portion of the packet is stored in cells indicated by and in a sequence indicated by traversing the cell list beginning with the starting cell id.

One method of retrieving a packet includes providing a memory arranged as a plurality of cells identified by cell id, each cell having a granularity of k individual memory addresses. A packet descriptor list identifying a starting cell id of the packet selected for retrieval is provided. A cell list indexed by cell id is provided. The cell list includes a selected packet list identifying a sequence of cells storing portions of the selected packet. The cell list includes a free cell list identifying cells available for storing data. The selected packet list and free cell list are each linked lists.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a communication network.

FIG. 2 illustrates one embodiment of a packet buffer memory and packet memory manager.

FIG. 3 illustrates one embodiment of a logical organization of the packet buffer memory.

FIG. 4 illustrates embodiments of data structures for managing the storage and retrieval of packets within the packet buffer memory.

FIG. 5 illustrates a one embodiment of a cell list.

FIG. 6 illustrates one embodiment of a method of managing the packet buffer memory.

FIG. 7 illustrates one embodiment of a packet memory manager execute function.

FIG. 8 illustrates one embodiment of a packet retrieve process that appends freed cells to the free cell list.

FIG. 9 illustrates one embodiment of a packet retrieve process that pre-pends freed cells to the free cell list.

FIG. 10 illustrates one embodiment of a packet descriptor list prior to and after a retrieval.

FIG. 11 illustrates one embodiment of a cell list prior to and after a retrieve operation that appends freed cells to the free cell list.

FIG. 12 illustrates one embodiment of a cell list prior to and after a retrieve operation that pre-pends freed cells to the free cell list.

FIG. 13 illustrates the write packet function including allocation and storing the packet.

FIG. 14 illustrates one embodiment of an allocate packet process.

FIG. 15 illustrates one embodiment of a store packet function.

FIG. 16 further illustrates the process of FIG. 15.

FIG. 17 illustrates one embodiment of a packet descriptor list at various stages of execution of a store packet function.

FIG. 18 illustrates one embodiment of a cell list at various stages of execution of the store packet function.

FIG. 19 illustrates one embodiment of a process for retrieving variable sized packets.

FIG. 20 illustrates one embodiment of a process for storing variable sized packets.

### DETAILED DESCRIPTION

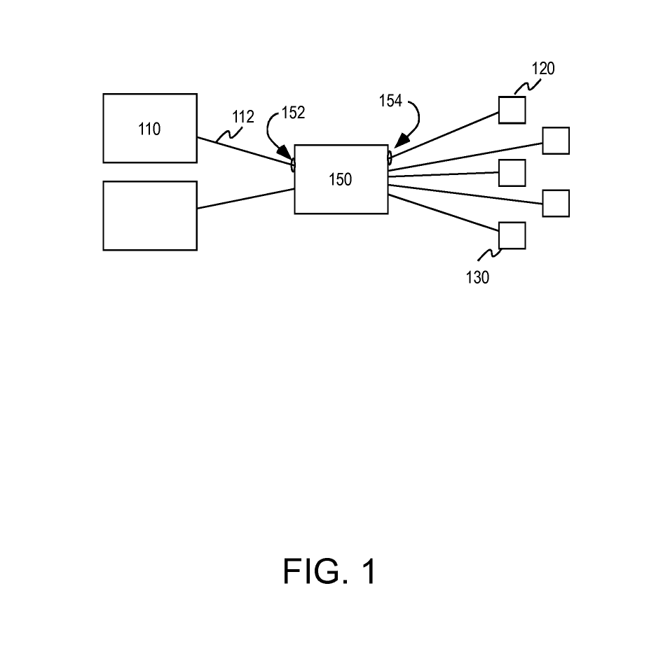

FIG. 1 illustrates one embodiment of a communication network including an intermediate node 150 and a plurality of nodes 110, 120, 130. Each node is communicatively coupled to the intermediate node by some communication path 112. Data may be communicated between the nodes 110, 120, 130 via the intermediate node 150 such that each of nodes 110, 120, and 130 may function as both a source and a destination of data.

The intermediate node is referred to as an “intermediate node” because the underlying functionality dictates that it is intermediate between the source and destination nodes. Data is communicating along communication paths 112 as serial data streams. A data streams may be received from one node 110 on one port 152 and communicated to another node 120 using another port 154 in accordance with the destination indicated by the data. Data is organized as “packets” for transport. Packet lengths can vary widely.

A packet is a variable-sized, related group of words of data. Packet lengths might range in some applications from 64 bytes to over 1500 bytes, for example. Typically, the beginning of a packet has header information describing attributes of the remainder of the packet.

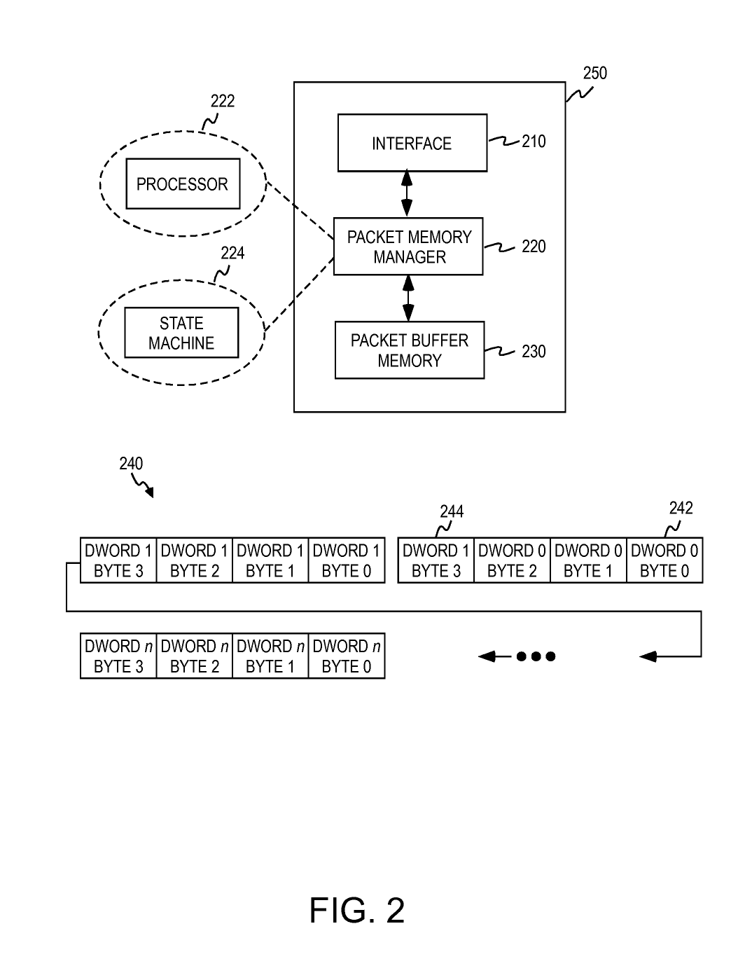

FIG. 2 illustrates one embodiment of a packet buffer memory and packet memory manager for the intermediate node 250. Packets 240 are stored in packet buffer memory 230. Packets are communicated through hardware interface 210. Interface 210 is the interface to the communication path communicatively coupling the intermediate node to other nodes. Packet memory manager 220 handles storing and retrieving packets from the packet buffer memory.

In one embodiment, packet memory manager 220 is embodied as a series of instructions executed by a processor 222 to achieve the management objectives (storing, retrieving, prioritizing, diagnostic, etc.) of the packet memory manager. For high-speed communications, the functionality of the processor may be reduced to a state machine 224. Such a state machine may be implemented using components such as Application Specific Integrated Circuits (ASICs) or Field Programmable Gate Arrays (FPGAs), or hybrids of these components. The state machine, processor, or hybrid may be referred to as the execution component.

In one embodiment, packet buffer memory 230 is a high-speed memory such as a quad data rate II (QDRII) random access memory. Such memories have two data ports that can run independently at twice conventional data rates which permits handling data at up to four times the rate of a conventional static random access memory (SRAM). A QDRII, for example, might handle four data words (i.e., a quad word) rather than a single data word per cycle.

The information contained in the packet may reflect encapsulation of data in accordance with the hierarchical layering that is typical of packetized data. Successively higher-level layers attach a header to the data provided by a lower-level layer. The header of a lower-level layer is merely part of the data to which a higher-level header may be attached when communicating to higher-level layers. When passing through successively lower-level layers, each layer strips off its associated header before passing the remainder of the packet to a lower-level layer.

In the illustrated embodiment, the lowest order bytes 242-244 contain the header identifying the packet 240. The packet may be made up of any number of bytes or words. In the illustrated embodiment, the packet is organized as quad words (i.e., two double words (DWORD)).

The logical organization of the memory should be selected to facilitate speed, however, other constraints such as cost and capacity also play a role in determining the logical memory organization.

For example, a packet buffer memory providing a fixed allocation of memory for each packet can facilitate high-speed processing. The memory allocation for each packet must be fixed at the largest possible packet length. If the packet lengths over a given timeframe exhibit a Gaussian distribution, then the mean packet length would be approximately one-half the maximum packet length. This logical organization would result in a fairly inefficient use of expensive high-speed memory.

Other approaches support variable packet sizes through other mechanisms. A layer of granularity may be introduced into the organization of the packet buffer memory. Such granularity can be introduced in the form of blocks to facilitate a more efficient use of the high-speed memory. Blocks may be either fixed in size or variable sized.

A variable-sized block approach can be very efficient in terms of usage of memory capacity. However, such approaches generally require a continuously moving stored packets in order to maximize and thus ensure the availability of free contiguous memory spaces. In essence, the memory must be continuously de-fragmented with respect to the available memory locations such that the available locations are physically contiguous. The speed at which the processor can perform such de-fragmentation operations becomes a significantly limiting factor to the increase in speed of packet communication.

An alternative fixed-sized block approach utilizes block sizes selected to more efficiently accommodate the typical packet length. Packets are block-aligned such that each packet starts at the beginning of a block. Unlike the earlier fixed-size block approach, however, the block size is reduced such that each packet may utilize several smaller blocks rather than a single, large fixed-size block. The minimum block size is thus not constrained to accommodate the longest possible packet. The term “cell” is used to aid in distinguishing this approach from previous fixed-size block approaches.

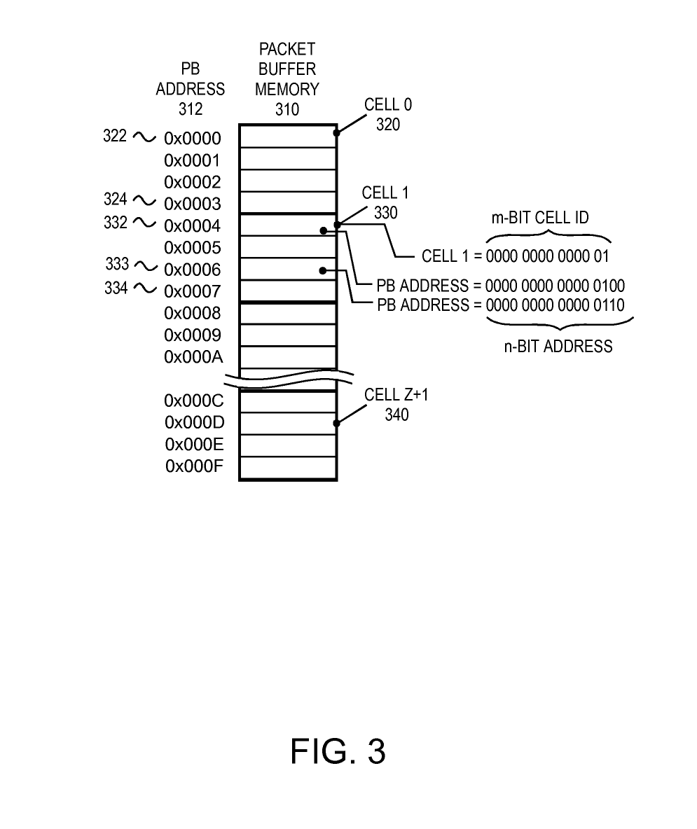

FIG. 3 illustrates one embodiment of a logical organization of the packet buffer memory 310. Individual storage locations are identified by a packet buffer address 312. The address is n bits long. The storage capacity at each address 333 may be of sufficient width to store one or more words of data. In one embodiment, the storage capacity at each address is sufficiently wide to store a plurality of words of data as well as attribute bits or flags describing the data.

In order to facilitate variable-sized packets, the memory is logically segmented into blocks, regions, or cells 320, 330, 340. Each cell represents a group of k physically sequential or contiguous addresses of the memory (k>1). A cell id is used to describe a particular cell. In one embodiment, the cell id is m bits long where m<n as illustrated by the cell id of cell 330. The cell id, for example, may comprise the upper m bits of a memory address such that each cell has a granularity of 2^{n-m} memory addresses.

The cells provide a granularity smaller than the memory as a whole yet larger than a single address. Thus cell 320 includes addresses 322-324, cell 330 includes addresses 332-334, etc. The cell granularity may be re-defined prior to storing or retrieving any packets, but is not expected to change after or during packet storage or prior to or during packet retrieval. Thus in one embodiment there is a pre-determined fixed number of cells.

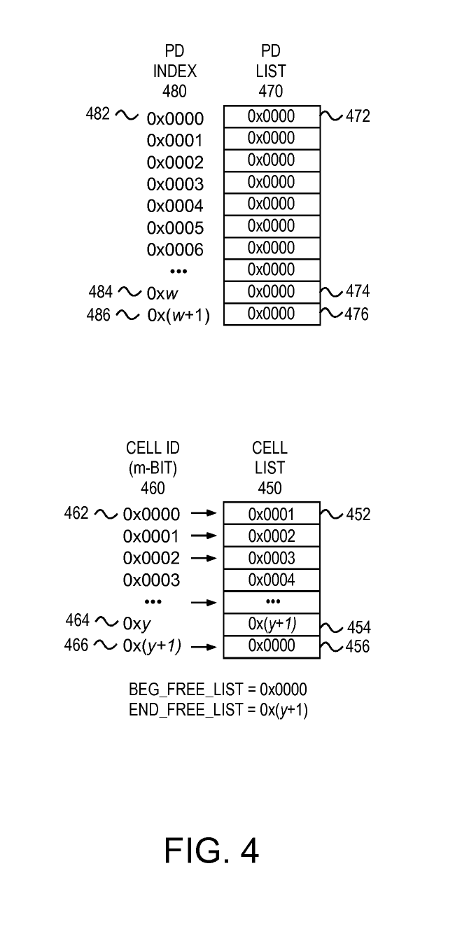

FIG. 4 illustrates embodiments of data structures for managing the storage and retrieval of packets within the packet buffer memory. A packet descriptor (PD) is created for each packet being stored within the packet buffer memory. The descriptors are maintained in a packet descriptor list (PD LIST 470). The packet descriptor list is indexed by a packet descriptor index (PD INDEX 480) such that each entry 472-476 of the list (and therefore each packet) may be referenced by a unique packet descriptor index 482-486.

In one embodiment, the packet descriptor includes a portion of the header of the packet, a status to indicate the validity of the packet descriptor, and the cell id of the cell containing the first word of the packet associated with that descriptor. In one embodiment, the descriptor includes a quality of service (QOS) indicator. Handling of packets may be prioritized based at least partly on the QOS indicator. Thus, for example, packets may be retrieved in an order other than the order received.

Upon initialization, the packet descriptor list is populated with values selected to signify that each entry 472-476 is available to be used for a packet descriptor. When a store packet request is received, the packet descriptor list is scanned to find an available entry referenced by its associated packet descriptor index. Once the packet associated with a specific packet descriptor index 484 is retrieved, the packet descriptor 474 associated with that packet descriptor index 484 is modified to reflect the availability of that packet descriptor list entry. Status flags (e.g., allocated/deallocated, available/busy/valid/invalid, etc.) may be set to mark the entry as available for another packet descriptor.

A cell list 450 data structure is used to identify the cells and the sequence of the cells to be used when storing or retrieving packets. The packet descriptor associated with that packet includes the starting cell id (and thus the entry point into the cell list) for that packet. When a packet is stored, each of the cells associated with that packet become unavailable (i.e., “used”) for subsequent storage until the packet has been retrieved at which point the cells become “free”. Each cell is thus either “used” or “free”.

The cell list has a plurality (y+1) of entries wherein at least y of the y+1 entries maps to a cell of the packet buffer memory. The cell list contains one or more linked lists. The cell list may be initialized to a single linked list, however, as store and retrieve operations are executed, the cell list may contain a plurality of linked lists. Although the cell list may be initialized to a monotonic order in accordance with the cell id, this order may not be preserved as packets are stored and retrieved given that packets may be retrieved in an order other than the order they were stored in.

One linked list is present for each stored packet. In addition, a free cell list is a linked list identifying cells available for storing packets. For conceptual purposes, cells may be referred to as “freed cells” after a retrieve operation until they have been added as a linked list to the free cell list at which point they become members of the free cells.

The term “linked list” is used because each cell list entry points to a cell list entry. Each entry 452-456 in the cell list 450 is referenced by a unique cell index that indicates the position of the entry in the list. The cell index may be readily mapped to a cell id 460. For conceptual simplicity, the term “cell id” in the context of the cell list may be interchanged with “cell index”. The cell list is thus effectively one or more linked lists indexed by cell id either explicitly or implicitly. Thus each entry 452-456 in the cell list 450 is referenced by a unique cell id 462-466. In one embodiment, the cell list is initialized to a single linked list representing a free cell list.

For demonstrative purposes, variables are introduced to illustrate programmatic list manipulation. Where possible, the same terms are used with the introduction of underscores (“_”) instead of spaces to separate multiple-word variables. The type of variable should be evidenced by the context (e.g., integer, real number, alphanumeric, list, etc.)

Thus CELL_LIST(CELL_ID) returns the value from the CELL_LIST associated with the specific CELL_INDEX/CELL_ID. Thus a first CELL_LIST value referenced by a first CELL_INDEX/CELL_ID identifies a second CELL_INDEX/CELL_ID associated with a second CELL_LIST value. In one embodiment, the CELL_LIST is initialized to a circular linked list of CELL_INDEX values when every cell is available such that regardless of the entry one starts from, one will traverse the entire CELL_LIST before being pointed back to the entry started from. However, a circular linked list is not required since the link at the end of the free cell list will not be traversed.

Reference to the cell list is all that is required to determine the “next cell” in logical sequence for reading or storing packets. The contents of cell list, however, merely indicate “next in sequence”. Additional information must be relied upon to guide retrieve and store operations. For example, the beginning of the linked list associated with a selected packet cannot be discerned from the cell list nor does the cell list even permit distinguishing between packets. The beginning and ending of individual packets cannot be determined from the cell list alone. Similarly, additional information is required to identify free cells for storing packets in order to avoid over-writing packet buffer memory that contains already used cells.

The PD_LIST identifies the beginning of each stored packet. The end of a stored packet is identified by the contents of the data stored within a cell. Each stored packet will have an associated linked list within the cell list. Available/freed cells are identified by a single linked list (“FREE_CELL_LIST”) within CELL_LIST. Through the linked list structure, the free cell list effectively provides logical contiguity for cells that may not be physically contiguous.

The beginning of the free cell list is identified by a BEG_FREE_LIST indicator. The end of the free cell list is identified by an END_FREE_LIST indicator. BEG_FREE_LIST is used to identify the first cell to be used when storing a packet. In the illustrated embodiment, BEG_FREE_LIST is initialized to 0x0000 and END_FREE_LIST is initialized to the cell id/index of the last entry of the list −0x(y+1). The term “first” refers to the first cell to be used rather than “lowest address” available cell given the current state of the CELL_LIST. If the END_FREE_LIST is encountered while allocating cells in accordance with the FREE_LIST while storing a packet, then there is insufficient space to continue.

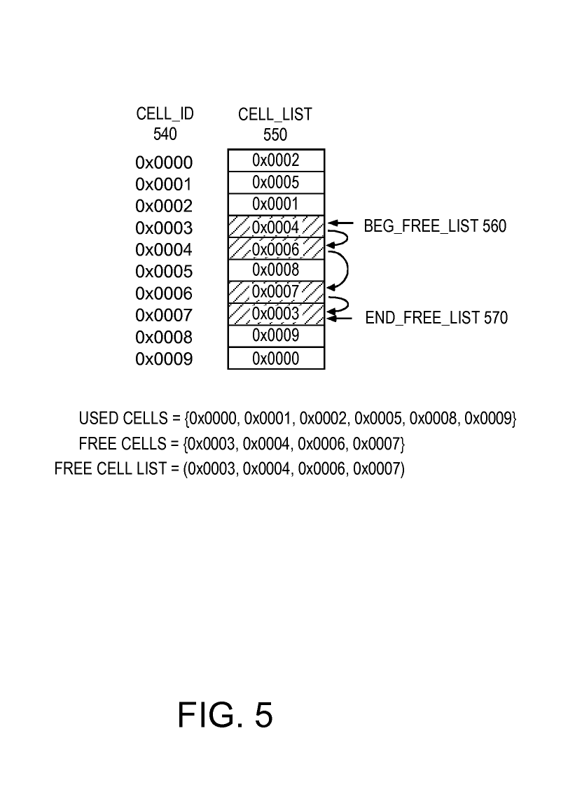

FIG. 5 illustrates one embodiment of the CELL_LIST 550 indexed by CELL_ID 540. The CELL_LIST in conjunction with a BEG_FREE_LIST 560 indicator and an END_FREE_LIST 570 indicator are utilized to effectively segregate the packet buffer memory into “used cells” and “free cells” for management. The packet descriptor list identifies the starting cell id of each stored packet and thus the entry point into CELL_LIST for each stored packet. The BEG_FREE_LIST and END_FREE_LIST indicators identify the beginning and end of the FREE_LIST.

Referring to FIG. 5, the “free cells” are indicated by the hatch marks and include {0x0003, 0x0004, 0x0006, 0x0007}. All other cells are used cells. Without regard to association with any packet, the used cells include {0x0000, 0x0001, 0x0002, 0x0005, 0x0008, 0x0009}. There is no actual maintaining of a used cell list. This list is simply provided to enhance the understanding of the principle of operation of the cell list. In the illustrated embodiment, the sequence of the free cells is defined by the links in the cell list such that the free cell list is (0x0003, 0x0004, 0x0006, 0x0007)

Generally, the packet descriptor list identifies the “entry point” into the cell list for each individual packet. The end of each packet is determined by an end-of-packet indicator within the last cell associated with that packet. The entry point into the free cells is indicated by the BEG_FREE_LIST. The last cell associated with the free cells is indicated by the END_FREE_LIST.

As long as the BEG_FREE_LIST and the END_FREE_LIST identify distinct cells, the portion of the linked list starting at the BEG_FREE_LIST and following the linked list until reaching the END_FREE_LIST represents free cells available for storage. When the BEG_FREE_LIST and END_FREE_LIST identify the same cell, then there are no free cells available in the packet buffer memory.

Store operations consume free cells and result in relative movement between the BEG_FREE_LIST and END_FREE_LIST in their positions on the CELL_LIST so as to reduce the number of free cells. Read operations free cells. Relative movement between the BEG_FREE_LIST and the END_FREE_LIST takes place by appending or pre-pending the freed cells onto the CELL_LIST to increase the number of free cells.

The CELL_LIST will not have any “sub-loops” between BEG_FREE_LIST and END_FREE_LIST. If one starts traversing the CELL_LIST beginning with the first BEG_FREE_LIST and following the links in the CELL_LIST, then no used cell will be encountered until the END_FREE_LIST is reached. “Sub-loops” are permissible in the CELL_LIST with respect to the used cells because the contents of the cells also control when to stop traversing the CELL_LIST. In particular, the CELL_ID pointed to by the last CELL_LIST entry associated with a specific stored packet is likely invalid. An invalid reference to a subsequent cell in the CELL_LIST has no bearing or effect, if the link will not be followed to retrieve a packet. Any such links are inherently resolved, if necessary, when the “freed” cells are added to the list of available cells.

Referring to FIG. 4, the BEG_FREE_LIST variable is initialized to the CELL_ID identifying the first cell of the memory available for storing a packet (i.e., index 462 (0x0000)). The END_FREE_LIST is initialized to the CELL_ID representing the end of the free list (i.e., index 466 (0x(y+1))). As packets are stored and retrieved, the values associated with these variables are modified. The END_FREE_LIST need not have a higher CELL_ID than the BEG_FREE_LIST. If the END_FREE_LIST and the BEG_FREE_LIST ever match, then the packet buffer memory is full.

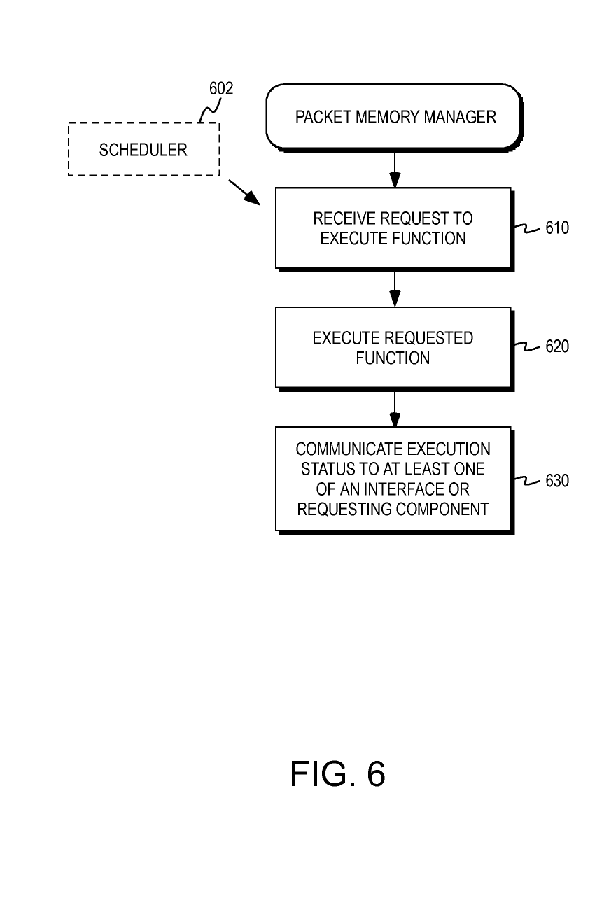

FIG. 6 illustrates one embodiment of a method of managing the packet buffer memory. In step 610, a request to execute a function such as a retrieving or storing a packet is received. The component (e.g., scheduler 602) to generate such requests may be incorporated within the packet memory manager, but would typically reside at a higher architectural level than the packet memory manager.

The function associated with that request is executed in step 620 (e.g., retrieve, store, etc.). The execution status may be communicated to at least one of the interface or the requesting component in step 630. For example, a code identifying a successful execution may be sent to the interface or requesting component if the request is successfully executed. The execution status may be self-evident from the result, for example, by providing a requested packet in response to a retrieve request. A code identifying a failed execution and/or the reason for failure may be sent to the interface or the higher-level component if the request is not successfully executed. Such codes, for example, may be utilized by the interface 210 of intermediate node 150 when communicating with other nodes and for diagnostic purposes. The codes may be statistically analyzed by higher-level components to identify problems within the node 150, problems with the connection of the node 150 to the remainder of the network, or problems with specific other nodes of the network.

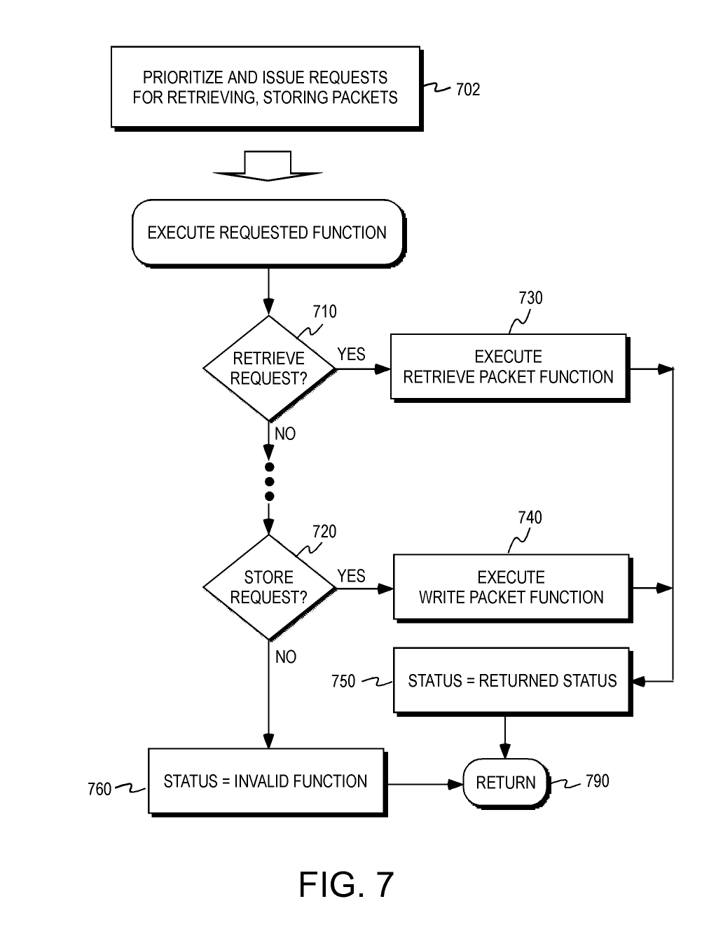

FIG. 7 illustrates one embodiment of portions of the process of FIG. 6 in greater detail. Block 702 corresponds to scheduler 602 or step 610 of FIG. 6 depending upon whether the scheduler is incorporated into the packet memory manager. Requests for retrieving and storing packets are prioritized and issued.

The requests may be prioritized based upon one or any combination of factors including type of request (e.g., retrieve or store), amount of packet buffer memory presently unavailable (i.e., how full the memory is), a priority indicated by a stored packet (e.g., a QOS indicator), the granularity of cells (i.e., how many addresses per cell), how long a packet has been stored, how large a stored packet is (if such information is tracked), whether execution of a previously issued request is pending, etc. These requests are issued by an architecturally higher-level component than the packet memory manager in one embodiment as illustrated in FIG. 6. At least some of the information relied upon for retrieving a specific packet is found in the packet descriptor list.

The prioritization process scans the PD_LIST to identify packets to retrieve. If the prioritization process prioritizes retrieving a selected packet over storing an incoming packet or retrieving another packet, the prioritization process issues a retrieval request along with the packet descriptor index (PD_INDEX) of the selected packet catalogued in the packet descriptor list (PD_LIST). Prioritization controls the order in which operations are initiated, but not necessarily the order in which they are completed. Concurrently executing requests are permissible.

Steps 710-790 correspond to the packet memory manager “execute requested function” step 620 of FIG. 6. Generally, the type of function requested is determined and then acted upon. In step 710, a determination is made regarding whether the request is a retrieve request. If so, then a packet retrieve function is performed in step 730 and the status of that retrieve function is returned in step 750.

In the event that the request is not a retrieve request, other tests are performed to determine which type of request has been received. In step 720, for example, a determination is made regarding whether the request is a store request. If so, then a packet write function is executed in step 740 and the status of that packet write function is returned in step 750.

If the function requested does not meet one of a specified set of functions as determined by 720-730, then the execution status of “invalid function” is returned in step 760.

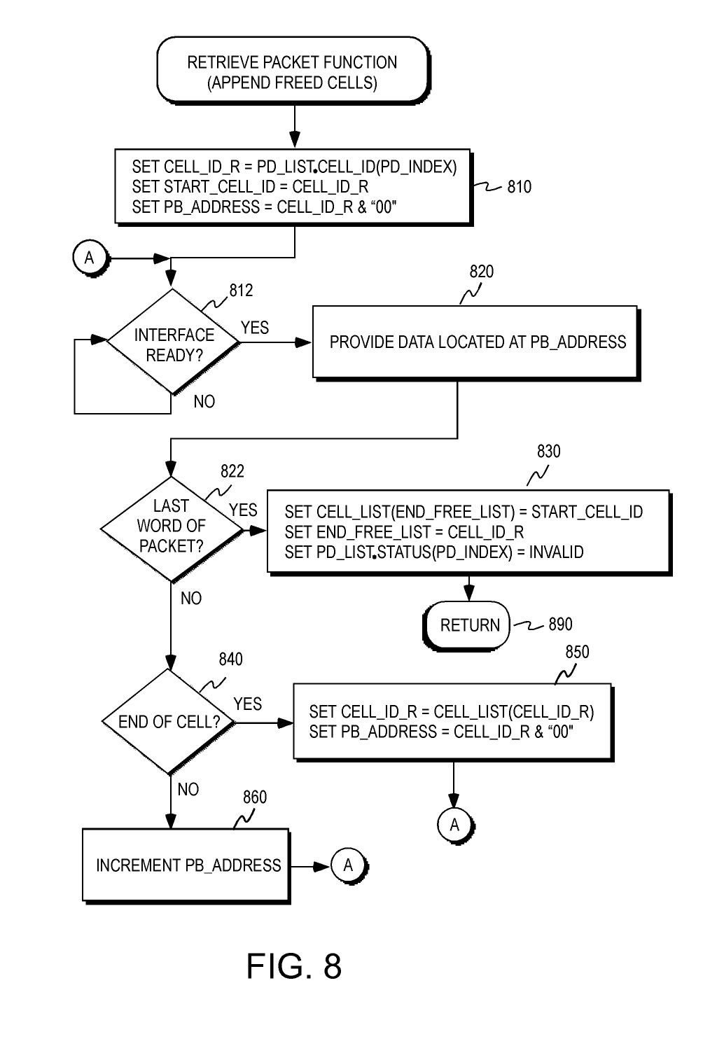

FIG. 8 illustrates one embodiment of a packet retrieve operation. The variables required for the retrieve function are initialized in step 810. Of note, BEG_FREE_LIST and END_FREE_LIST may be modified within a store or retrieve function but are not local variables with respect to either the packet retrieve or packet store operation. (“local” implies that the variable is accessible and modifiable only by that function).

The packet retrieve function is invoked with a packet descriptor index, PD_INDEX. Each packet descriptor in the PD_LIST contains header information from its associated packet, flags, and the CELL_ID of the cell containing the first word of the packet. Although CELL_ID may be defined locally to each of the store and retrieve functions, CELL_ID_R is used to describe the local variable for the retrieve packet function and CELL_ID_S is used to describe the local variable for the store packet function for conceptual distinction.

Local variable CELL_ID_R is set to the CELL_ID extracted from the PD at PD_INDEX of the PD_LIST in step 810. The nomenclature “YYYY.xxxx(zzzz)” indicates the xxxx field of the zzzz entry of the YYYY list. START_CELL_ID is utilized to memorialize the starting cell to enable adding any freed cells to the free cell list. CELL_ID_R is modified during the retrieve process so a local variable START_CELL_ID is set to CELL_ID_R in step 810. The starting address for retrieval is obtained by concatenating the CELL_ID or START_CELL_ID with the appropriate string to completely define an address, PB_ADDRESS.

Generally, the value to concatenate is determined by the granularity of the cell. Packets are cell-aligned so that a packet starts at the beginning of a cell. Cells do not contain valid data from more than one packet, although cells may contain fragments of invalid predecessor packets beyond the end-of-packet for the current packet. If the last portion of a packet does not require a full cell for storage, for example, then there will be addresses within the cell that are beyond the address containing the end of a packet. Such addresses may contain data from predecessor packets that the cell was previously associated with. Thus memory locations may be over-written as used rather than initializing/erasing cell contents prior to use.

Sufficient bits must be concatenated to enable distinguishing each packet buffer address in the cell. Referring to FIG. 3, for example, the illustrated cells 330 have a granularity of four addressable memory locations. Four addressable memory locations require two bits. Thus the first address of the cell is formed by concatenating “00” to CELL_ID_R. For efficiency, cells may be organized to have a granularity that is an integer power of 2 (i.e., 2^{j}, where j is a positive integer). Generally, the number of bits to be concatenated will be the difference between the number of bits in the PB_ADDRESS and CELL_ID (i.e., n−m).

Step 812 determines whether the communication interface is ready to receive one or more words of a retrieved packet. Once ready, one or more words of data stored at PB_ADDRESS are retrieved and provided to the interface in step 820.

Step 830 determines whether the end-of-packet has been reached. In one embodiment, this may be determined by examining attribute bits of the most recently retrieved data. If the end-of-packet has not been reached, then the retrieve operation must proceed to the next address to obtain sequential portions of the requested packet.

Although addresses within a cell may be physically contiguous and sequential, such continuity does not exist across cell boundaries. Accordingly step 840, determines whether the current address represents the end of the cell. If so, then the retrieve operation proceeds to the first address within the next cell as determined by the CELL_LIST linked list. Step 850 sets the CELL_ID_R to the next cell in the sequence as determined by the value of the CELL_LIST at the current CELL_INDEX (i.e., CELL_LIST(CELL_ID_R)). The next address from which to begin fetching data is formed by concatenating the CELL_ID_R with the appropriate value (e.g., “00”). The retrieve operation then proceeds to point A to continue fetching the data associated with the requested packet.

Referring to step 840, if the end of cell has not been reached then the retrieve process may proceed to the next sequential address within the cell. In step 860, this is accomplished by incrementing the current PB_ADDRESS. The retrieve operation then proceeds to point A to continue fetching the data associated with the requested packet.

Once the end-of-packet has been reached as determined in step 822, then all the cells associated with the current packet become “freed” cells and may be either appended or pre-pended onto the free cell list. In the present illustration, the freed cells are appended onto the free cell list in step 830. The CELL_LIST is modified such that the present END_FREE_LIST points to the first cell associated with this retrieve operation (i.e., START_CELL_ID). The END_FREE_LIST is then set to the last cell associated with this retrieve operation as indicated by CELL_ID_R. The status field of the packet descriptor list entry corresponding to the retrieved packet is set to “invalid” to indicate that the slot may be used for cataloguing a subsequent packet.

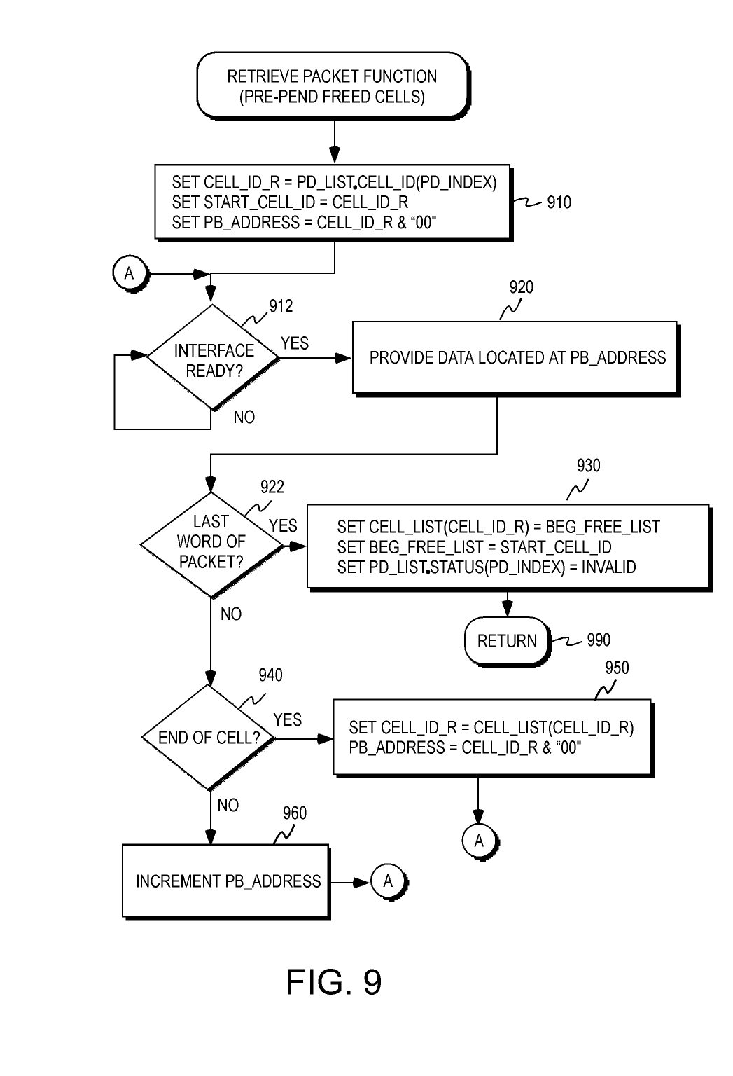

FIG. 9 illustrates an alternative embodiment of the retrieve operation. Generally, all the steps are identical to counterpart steps of FIG. 8 with the exception of step 930.

The packet retrieve function is invoked with a packet descriptor index, PD_INDEX. Each packet descriptor in the PD_LIST contains header information from its associated packet, flags, and the CELL_ID containing the first word of the packet. The variables required for the retrieve function are initialized in step 910.

Local variable CELL_ID_R is set to the CELL_ID extracted from the PD at PD_INDEX of the PD_LIST in step 910. START_CELL_ID is utilized to memorialize the starting cell to enable adding any freed cells to the free cell list. CELL_ID_R is modified during the retrieve process so the local variable START_CELL_ID is set to CELL_ID_R in step 910. The starting address for retrieval is obtained by concatenating the CELL_ID or START_CELL_ID with the appropriate string to completely define an address, PB_ADDRESS.

Generally, the value to concatenate is determined by the granularity of the cell. In the illustrated embodiment, the appropriate PB_ADDRESS is formed by concatenating a value of “00” to the CELL_ID_R to fully define the first address of the cell. The number of bits to be concatenated will be the difference between the number of bits in the PB_ADDRESS and CELL_ID (i.e., n−m).

Step 912 determines whether the communication interface is ready to receive one or more words of a retrieved packet. Once ready, one or more words of data stored at PB_ADDRESS are retrieved and provided to the interface in step 920.

Step 922 determines whether the end-of-packet has been reached. In one embodiment, this may be determined by examining attribute bits of the most recently retrieved data. If the end-of-packet has not been reached, then the retrieve operation must proceed to the next address to obtain sequential portions of the requested packet.

Although addresses within a cell may be physically contiguous and sequential, such continuity does not exist across cell boundaries. Accordingly step 940 determines whether the current address represents the end of the cell. If so, then the retrieve operation proceeds to the first address within the next cell as determined by the CELL_LIST linked list. Step 950 sets the CELL_ID_R to the next cell in the sequence as determined by the value of the CELL_LIST at the current CELL_INDEX (i.e., CELL_LIST(CELL_ID_R)). The address from which to begin fetching data is formed by concatenating the CELL_ID_R with the appropriate value (e.g., “00”). The retrieve operation then proceeds to point A to continue fetching the data associated with the requested packet.

Referring to step 940, if the end of cell has not been reached then the retrieve process may proceed to the next sequential address within the cell. In step 960, this is accomplished by incrementing the current PB_ADDRESS. The retrieve operation then proceeds to point A to continue fetching the data associated with the requested packet.

Once the end of packet has been reached as determined in step 922, then all the cells associated with the current packet become “freed” cells and may be either appended or pre-pended onto the FREE_CELL_LIST. In the present illustration, the freed cells are pre-pended onto the FREE_CELL_LIST in step 930. The CELL_LIST is modified such that the last cell read (CELL_ID_R) points to the present BEG_FREE_LIST. The BEG_FREE_LIST is then set to the first cell associated with this retrieve operation (i.e., START_CELL_ID). The status field of the packet descriptor list entry corresponding to the retrieved packet is set to “invalid” to indicate that the slot may be used for cataloguing a subsequent packet.

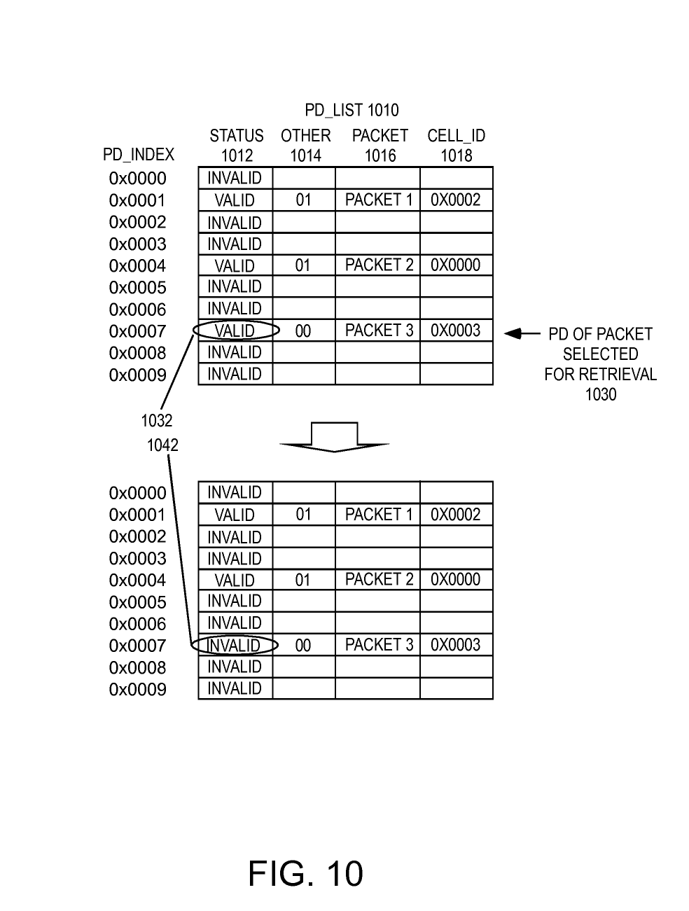

FIG. 10 illustrates one embodiment of a PD_LIST 1010 before and after retrieving a packet. Each PD includes a status 1012 indicating validity of the associated packet, a portion of the packet header (PACKET 1016), the CELL_ID 1018 of the cell at which the identified packet starts, and other 1014 information related to that packet. The PD 1030 of the packet selected for retrieval has a status 1032 indicating that it is a valid PD entry. After retrieval, the status is updated to indicate that it is an invalid PD entry and thus no longer associated with a packet as indicated by status 1042.

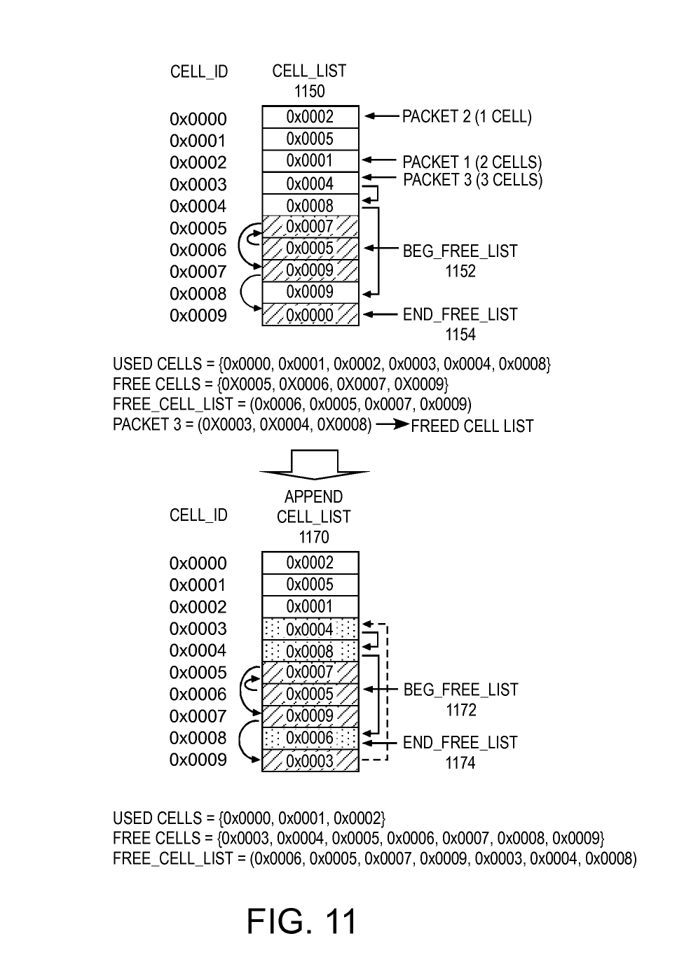

FIG. 11 illustrates one embodiment of a CELL_LIST prior to and after the retrieve operation that appends freed cells to the free cell list (such as illustrated in FIG. 8). Prior to retrieval, the free cells include {0x0005, 0x0006, 0x0007, 0x0009}. The used cells include {0x0000, 0x0001, 0x0002, 0x0003, 0x0004, 0x0008}. BEG_FREE_LIST 1152 identifies CELL_ID 0x0006 as the start of the FREE_CELL_LIST. END_FREE_LIST 1154 identifies CELL_ID 0x0009 as the end of the FREE_CELL_LIST. The FREE_CELL_LIST is thus (0x0006, 0x0005, 0x0007, 0x0009).

The linked list for PACKET 3 is (0x0003, 0x0004, 0x0008). After retrieval, the PACKET 3 cells form a FREED_CELL_LIST. CELL_LIST 1170 illustrates the CELL_LIST 1170 after appending the FREED_CELL_LIST (i.e., the cell list entries corresponding to the retrieved packet) to the FREE_CELL_LIST. The BEG_FREE_LIST 1172 indicator does not change and continues to identify CELL_ID 0x0006 as the start of the FREE_CELL_LIST. The CELL_LIST entry (i.e., 0x0009) identified by the former END_FREE_LIST is modified to point to the first value (0x0003) of the FREE_CELL_LIST. The END_FREE_LIST 1174 indicator is changed to point to the last value (0x0008) of the FREED_CELL_LIST.

After the appending step, the used cells are {0x0000, 0x0001, 0x0002}. The free cells include {0x0003, 0x0004, 0x0005, 0x0006, 0x0007, 0x0008, 0x0009}. The FREE_CELL_LIST becomes (0x0006, 0x0005, 0x0007, 0x0009, 0x0003, 0x0004, 0x0008).

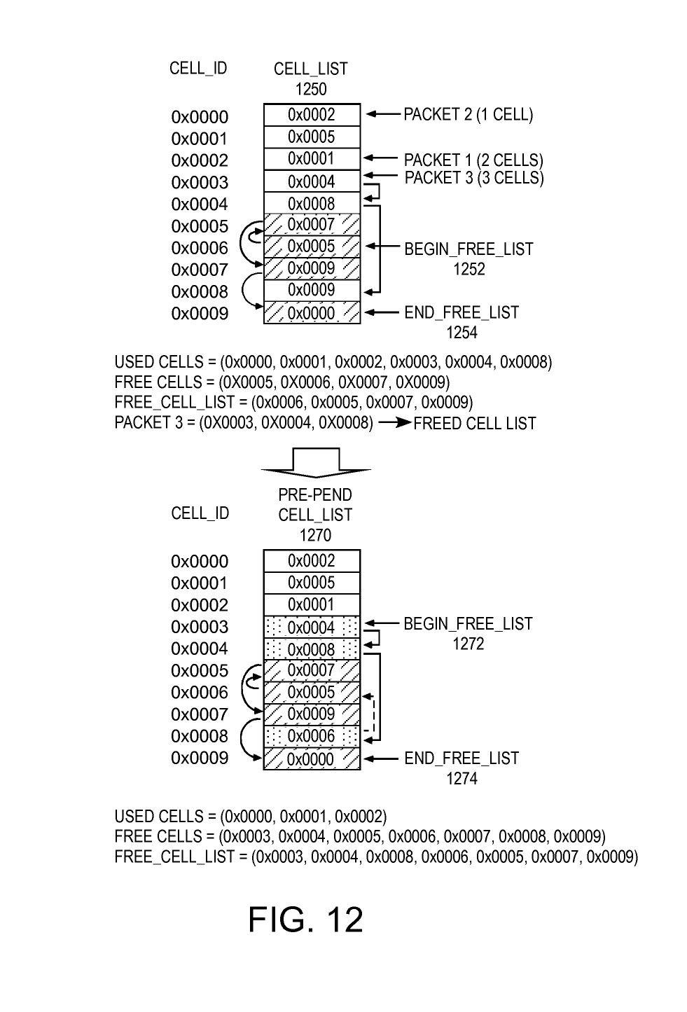

FIG. 12 illustrates one embodiment of a CELL_LIST prior to and after the retrieve operation that pre-pends freed cells to the free cell list (such as illustrated in FIG. 9). Prior to retrieval, the free cells include {0x0005, 0x0006, 0x0007, 0x0009}. The used cells include {0x0000, 0x0001, 0x0002, 0x0003, 0x0004, 0x0008}. BEG_FREE_LIST 1252 identifies CELL_INDEX 0x0006 as the start of the FREE_CELL_LIST. END_FREE_LIST 1254 identifies CELL_INDEX 0x0009 as the end of the FREE_CELL_LIST. The FREE_CELL_LIST is thus (0x0006, 0x0005, 0x0007, 0x0009).

The linked list for PACKET 3 is (0x0003, 0x0004, 0x0008). After retrieval, the PACKET 3 cells form a FREED_CELL_LIST. CELL_LIST 1270 illustrates the CELL_LIST 1270 after pre-pending the FREED_CELL_LIST to the FREE_CELL_LIST. The CELL_LIST entry (i.e., 0x0009) identified by the end of the FREED_CELL_LIST is modified to point to the entry (0x0006) identified by the former BEG_FREE_LIST 1452. BEG_FREE_LIST 1472 is changed to identify the first value (0x0003) of the FREED_CELL_LIST. END_FREE_LIST 1274 is unchanged and continues to identify CELL_INDEX 0x0009 as the end of the FREE_CELL_LIST.

After the pre-pending step, the used cells are {0x0000, 0x0001, 0x0002}. The free cells include {0x0003, 0x0004, 0x0005, 0x0006, 0x0007, 0x0008, 0x0009}. The FREE_CELL_LIST becomes (0x0003, 0x0004, 0x0008, 0x0006, 0x0005, 0x0007, 0x0009).

Comparison of FIGS. 11-12 illustrates that appending the FREED_CELL_LIST to the FREE_CELL_LIST results in changing the END_FREE_LIST and leaving the BEG_FREE_LIST unchanged. Pre-pending the FREED_CELL_LIST to the FREE_CELL_LIST results in changing the BEG_CELL_LIST and leaving the END_FREE_LIST unchanged.

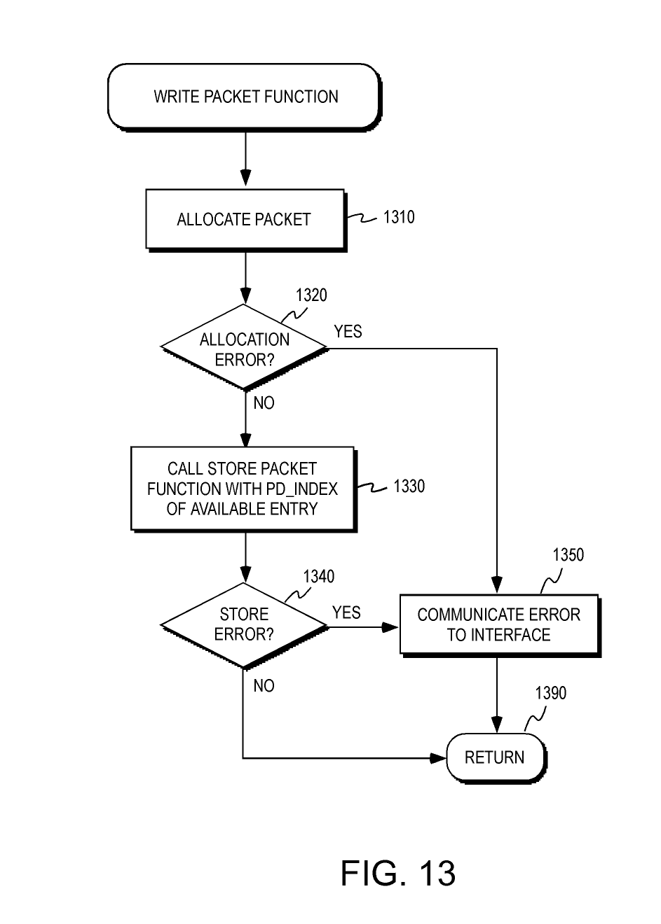

FIG. 13 illustrates one embodiment of a packet write function including allocating and storing the packet. In step 1310 executes an allocate packet function. Although the length of the packet is unknown, there must be an available PD_LIST entry (i.e., “directory space”) as well as sufficient packet buffer memory to start storing the packet.

Step 1320 determines whether an allocation error occurred. If so, then the error is communicated to the interface in step 1350 after which the write packet function returns in step 1390. In various embodiments, the interface might either retry by preserving the data associated with the incoming packet and waiting. Alternatively, the interface may purge the data associated with the incoming packet.

If no allocation error occurred, then the store packet function is called with the PD_INDEX of the entry selected from the PD_LIST in step 1330. If the store function terminates in an error as determined by step 1340, then the error is communicated to the interface in step 1350. Otherwise, the write packet function is completed in step 1390.

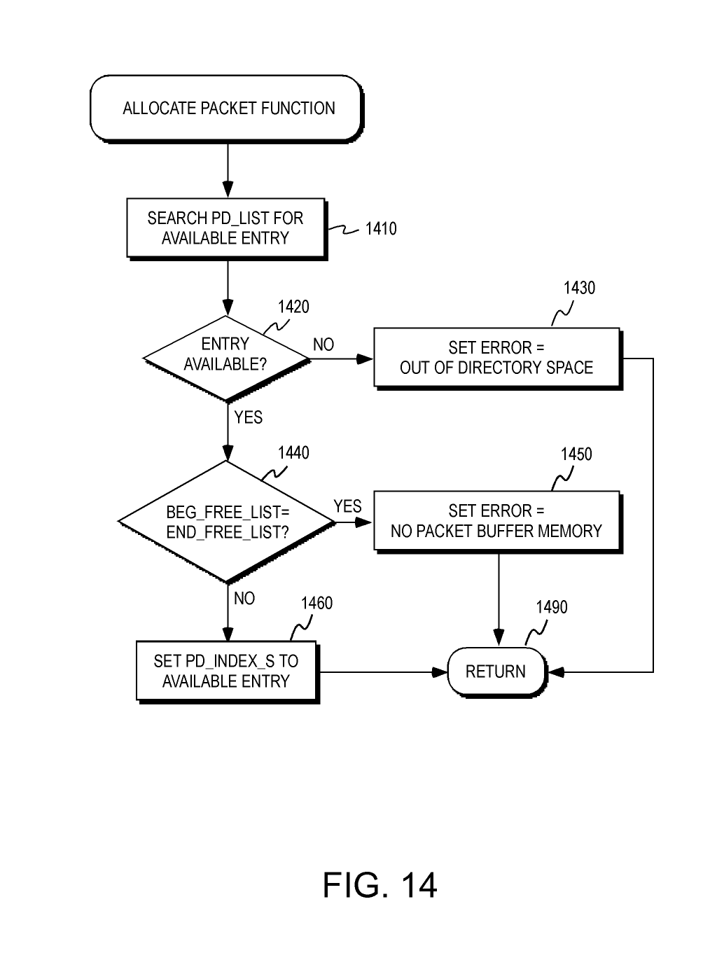

FIG. 14 illustrates one embodiment of the allocate packet function. The PD_LIST is searched for an available entry in step 1410. Any PD_LIST entry with a status of “invalid” or “available” is available. If no entry is available as determined by step 1420, then an error indicator is set to indicate “out of directory space” in step 1430 before returning in step 1490.

If an entry is available, there still must be at least one cell available to start writing the incoming packet. Step 1440 determines whether the BEG_FREE_LIST is the same as the END_FREE_LIST. If so, then an error indicator is set to indicate “no packet buffer memory” in step 1450 before returning in step 1490. If an entry is available, then the PD_INDEX_S is set to the available entry prior to returning in step 1490.

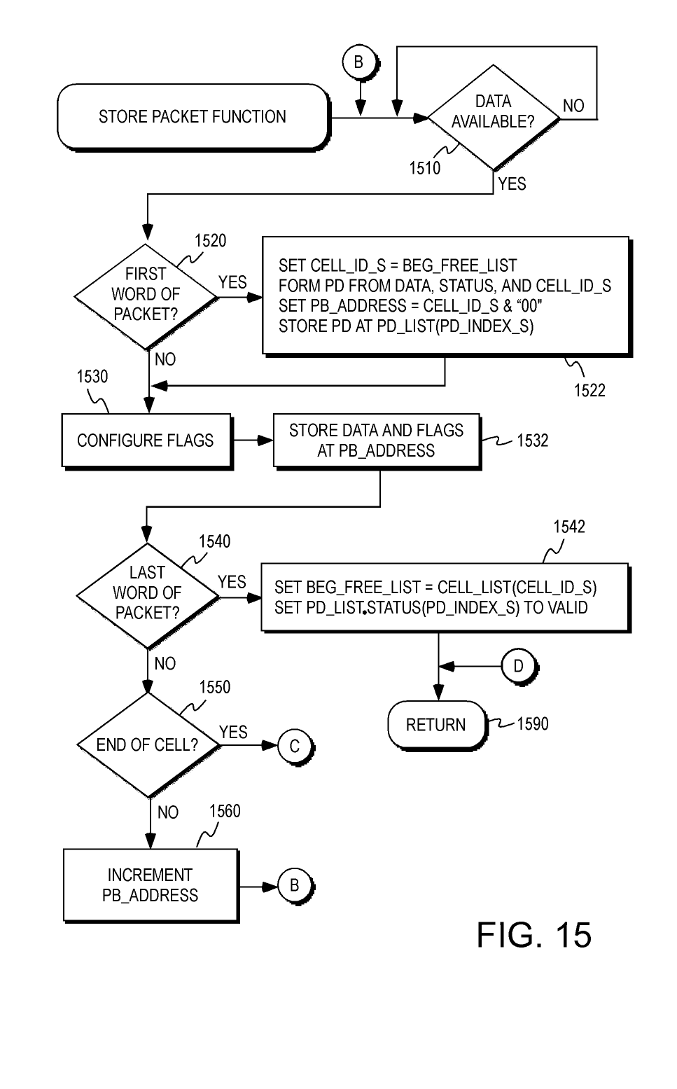

FIG. 15 illustrates one embodiment of the “store” function. The interface receives the serially communicated packet data. When the store packet function is invoked, the interface is presumed to ensure that all data between a first word of a packet and a last word of a packet belong to the same packet. Although the data is serially received by the interface, the interface may buffer the incoming data until a pre-determined threshold is reached before providing it to the store function. For example, the interface may provide the data as groups of words rather than single words, bytes, or bits.

The store function is initially called with a PD_INDEX that identifies an available entry in the PD_LIST for a new packet descriptor (PD). PD_INDEX_S is the local variable for the store operation.

Beginning with step 1510, the process determines whether any data has been received. If not, then the store function must wait until data is received from the interface before proceeding.

Once data is available from the interface, step 1520 determines whether the data identifies the first word of a packet. If so, step 1522 performs initialization of variables used for storing this packet.

For example, a CELL_ID_S is used locally with the invocation of the store packet function. CELL_ID_S is a variable that indicates the current cell during the store process. The CELL_ID_S is initialized to the global BEG_FREE_LIST variable. At this point, CELL_ID_S indicates the cell selected to contain the first word of the data. A packet descriptor is formed from the data, CELL_ID_S, and status.

“Status” bits may be used to ensure preservation of the allocated packet descriptor list entry while storing the packet. In one embodiment, status bits are used to indicate “valid”, “busy”, or “invalid/free”. After allocation and prior to completing storage of the packet, the packet descriptor is marked with a “busy” status. Until the packet is successfully written, the packet descriptor is provided with a status of “busy”. The status can be detected by prioritization processes to ensure avoidance of initiating retrieval of packets that are not yet fully stored.

The packet buffer address at which the first word of the data will be written is determined. In the present embodiment, the packet buffer address is determined by concatenating CELL_ID_S with values (e.g., “00”) such that the result identifies the address of the beginning of the selected cell.

The packet descriptor is stored at the PD_LIST entry indicated by the provided PD_INDEX (i.e., PD_LIST(PD_INDEX_S)) in step 1522.

Flags are optionally configured in step 1530. These flags may be used to indicate, for example, first word of packet, last word of packet, error correction or parity bits, etc. The data and flags are stored at PB_ADDRESS in step 1532. In one embodiment, the packet buffer memory is physically organized to accommodate multiple words and flags for each address.

Step 1540 determines whether the data includes the end-of-packet. If so, then the next available cell is determined by the linked list. As will be subsequently discussed, the store packet function preserves the END_FREE_LIST as such and does not store packet portions in the last free cell. Accordingly the CELL_ID_S at this point is not the END_FREE_LIST. Thus, one is guaranteed that the next cell in the linked list is not already being used. The BEG_FREE_LIST is updated by setting BEG_FREE_LIST=CELL_LIST(CELL_ID_S). The packet descriptor in the PD_LIST may also be updated to reflect that the store operation was successful. Thus in one embodiment PD_LIST.STATUS(PD_INDEX_S) is set to “valid” in step 1542. The store function may then terminate in step 1590.

If the data does not include the last word of the packet as determined by step 1540, then step 1550 determines whether the end of the current cell has been reached. This may be determined, for example, by examining the PB_ADDRESS. In the present example given 4 addresses per cell and the cell to address mapping, the end of the current cell is indicated when the last two bits of PB_ADDRESS are “11”.

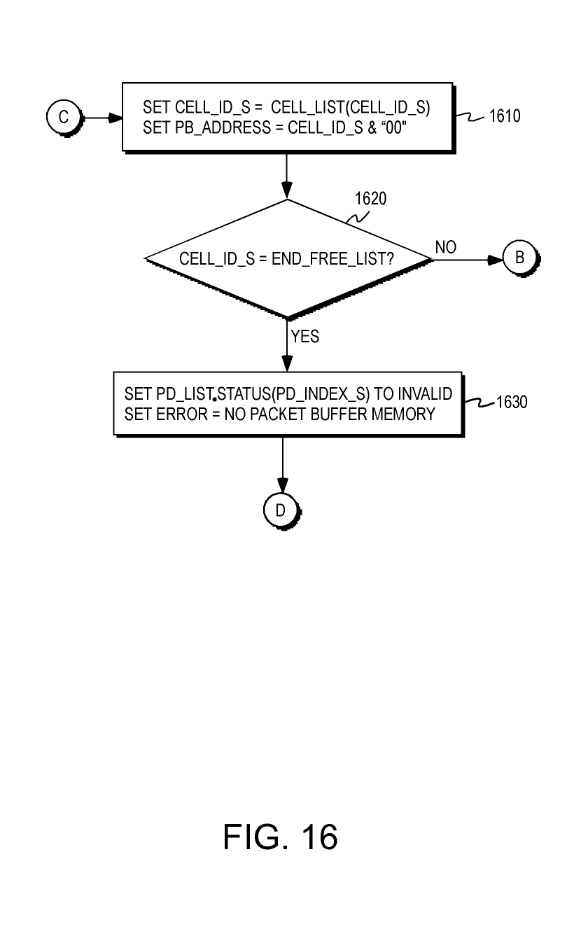

If the end of the current cell has been reached, processing continues with FIG. 16 to advance to the next cell in the FREE_CELL_LIST for storing the packet. In step 1610, CELL_ID_S is set to CELL_ID(CELL_ID_S). PB_ADDRESS is established by concatenation of “00” to the CELL_ID_S to identify the first physical address of the cell.

Step 1620 determines whether the end of the FREE_CELL_LIST has been reached by comparing CELL_ID_S with END_OF_LIST. If not, then processing continues with step 1510 of FIG. 15 to continue storing portions of the packet.

If the end of the FREE_CELL_LIST has been reached, then the presumption is that there is insufficient packet buffer memory to store the packet. Accordingly, the status of the PD_LIST for the current packet is set to invalid in step 1630. In addition, an error status may be set to indicate out of packet buffer memory. The process then terminates with step 1590 of FIG. 15.

Referring to FIG. 15, if step 1550 determines that the end of the current cell has not been reached as determined from step 1550, then the next PB_ADDRESS is contiguous to the current PB_ADDRESS and may be calculated by simply incrementing the current PB_ADDRESS in step 1560. Once PB_ADDRESS is determined, the process continues with step 1510 to wait for more data.

The store packet function moves the BEG_FREE_LIST of the FREE_CELL_LIST while leaving the END_FREE_LIST unchanged. The retrieve packet function moves the BEG_FREE_LIST or the END_FREE_LIST depending upon whether the resulting FREED_CELL_LIST is pre-pended or appended, respectively, to the FREE_CELL_LIST. Accordingly, appending imposes the requirement that the END_FREE_LIST may be associated with any CELL_INDEX. Pre-pending, however, imposes no such requirement. Given that the store packet function does not store data in any cell associated with the END_FREE_LIST, the END_FREE_LIST does not need to map to any actual cell within the packet buffer memory. Thus when pre=pending, only y of the y+1 CELL_INDEXes of the CELL_LIST must map to the packet buffer memory.

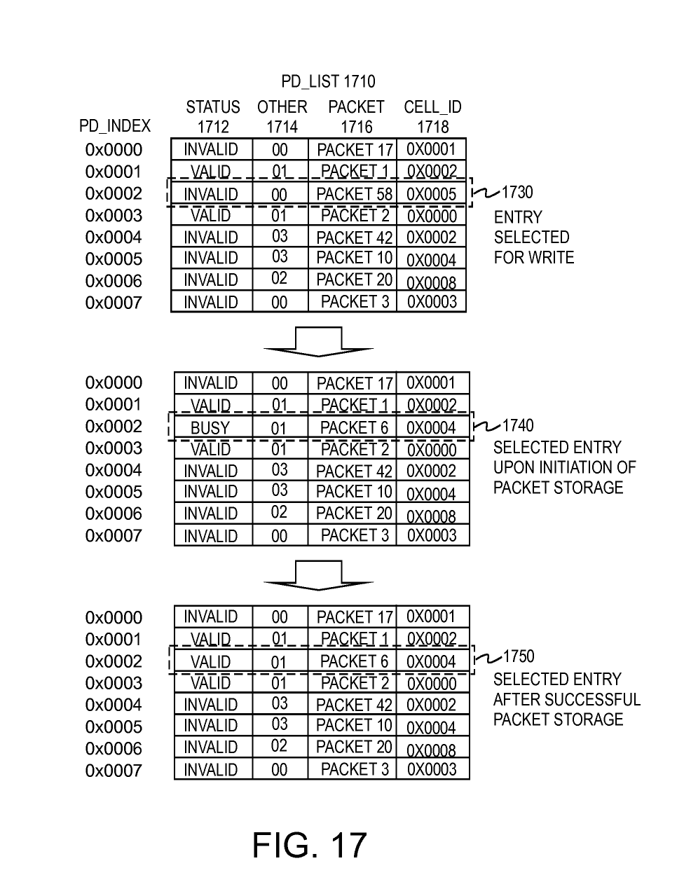

FIG. 17 illustrates one embodiment of a packet descriptor list at various stages of execution of a store packet function. The packet descriptor list includes a status 1712, packet description 1716, and the starting cell 1718 for each packet stored. Other 1714 information may also be associated with each packet. The allocation function identifies the PD INDEX of an available entry 1730 prior to initiating the store packet function. The availability of the entry is indicated by the “invalid” status.

Once the store packet function is initiated, the packet descriptor entry is updated (1740) to reflect the appropriate information for the packet being stored (PACKET 6). In particular, the status is updated to “busy” and the starting cell id (determined by the allocation function) is updated.

If the store packet function is successful, the status for the selected packet descriptor 1750 is updated to “valid”. If not the status will be reset to “invalid” and thus made available for a subsequent packet.

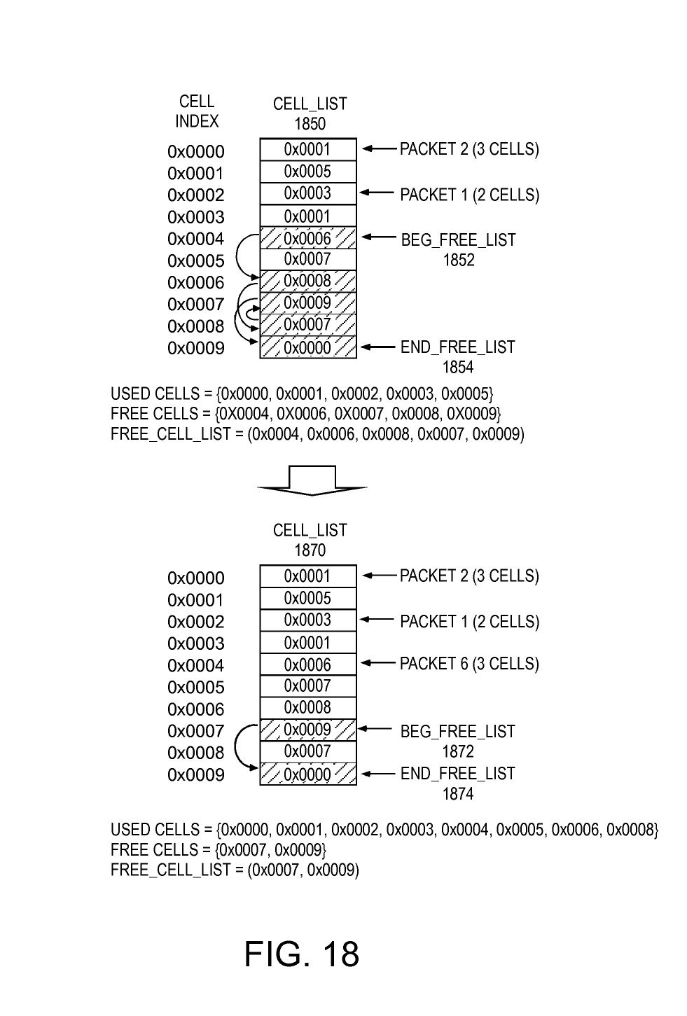

FIG. 18 illustrates one embodiment of a cell list at various stages of execution of the store packet function. CELL_LIST 1850 represents the status of the cell list prior to storing PACKET 6. By using the packet descriptor list of FIG. 17, CELL_LIST 1850 indicates the sequence of cells associated with valid PACKET 1 and PACKET 2. The FREE_CELL_LIST starts with index 0x0004 as indicated by BEG_FREE_LIST 1852. The FREE_CELL_LIST ends with index 0x0009 as indicated by END_FREE_LIST 1854. As noted previously, the index associated with END_FREE_LIST need not map to a usable cell of the packet buffer memory

In the illustrated embodiment PACKET 6 requires 3 cells for storage. Prior to storing any portion of PACKET 6, the free cell list starts at 0x0004 as indicated by BEG_FREE_LIST 1852. Thus 0x0004 is allocated as the starting CELL_ID as indicated by packet descriptor 1740 of FIG. 17. Traversing the FREE_CELL_LIST, PACKET 6 is stored using cells 0x0004, 0x0006, and 0x0008. The beginning of the free cell list is thus advanced to 0x0007 as indicated by BEG_FREE_LIST 1872. The end of the free cell list remains at 0x0009 as indicated by END_FREE_LIST 1874.

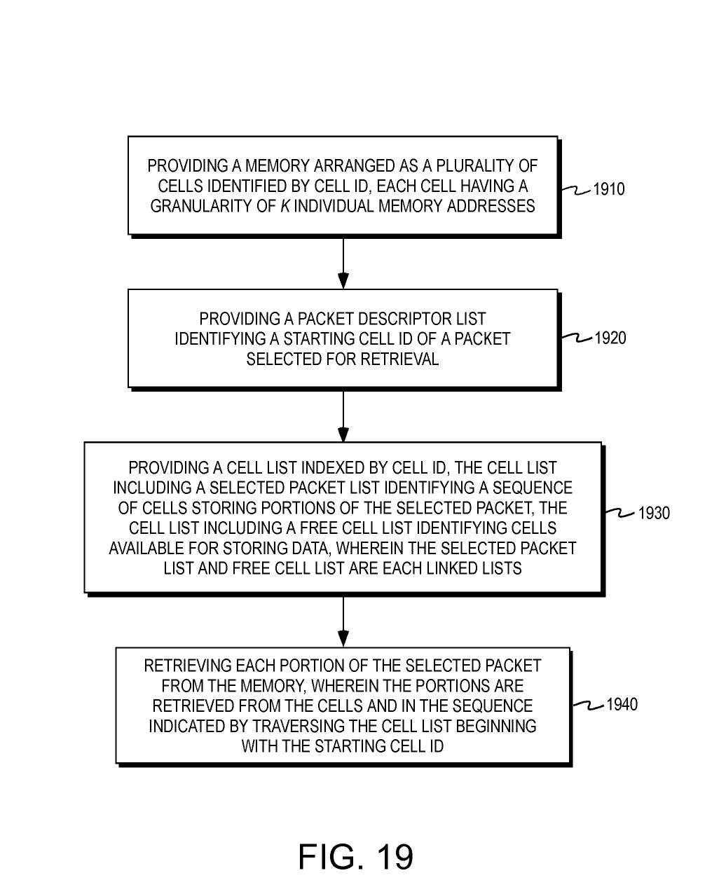

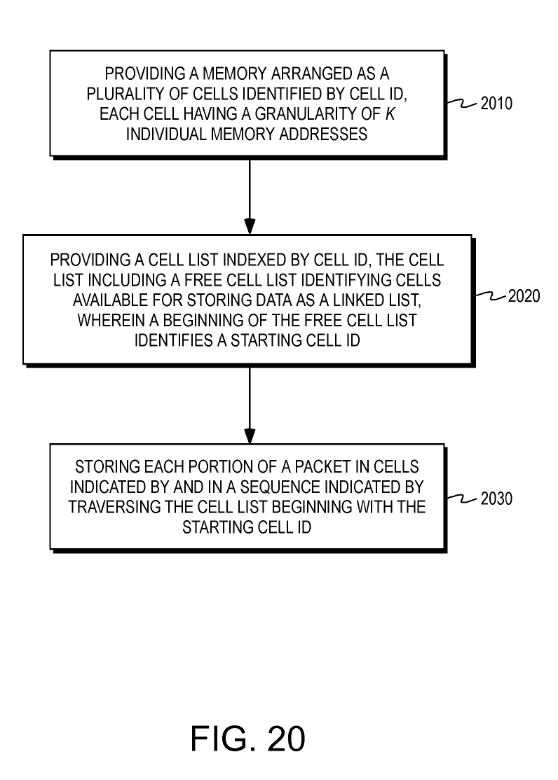

The storage and retrieval functions may be abstracted to generalized processes as set forth in FIGS. 19-20. FIG. 19 illustrates one embodiment of a process for retrieving variable sized packets from a packet buffer memory.

A memory arranged as a plurality of cells identified by cell id is provided in step 1910. Each cell has a granularity of k individual memory addresses. In step 1920, a packet descriptor list identifying a starting cell id of a packet selected for retrieval is provided. In step 1930, a cell list indexed by cell id is provided. The cell list includes a selected packet list identifying a sequence of cells storing portions of the selected packet. The cell list includes a free cell list identifying cells available for storing data, wherein the selected packet list and the free cell list are each linked lists. Each portion of the selected packet is retrieved from the memory in step 1940. The portions are retrieved from the cells indicated by and in the sequence indicated by traversing the cell list beginning with the starting cell id.

FIG. 20 illustrates one embodiment of a process for storing variable sized packets in a packet buffer memory. A memory arranged as a plurality of cells identified by cell id is provided in step 2010. Each cell has a granularity of k individual memory addresses. A cell list indexed by cell id is provided in step 2020. The cell list includes a free cell list identifying cells available for storing data as a linked list. A beginning of the free cell list identifies a starting cell id. In step 2030, each portion of a packet is stored in cells indicated by and in a sequence indicated by traversing the cell list beginning with the starting cell id.

Various methods and apparatus for managing a packet buffer memory have been described. In particular, methods and apparatus for storing and retrieving packets in any order utilizing any sequence of cells are described.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
a) providing a memory arranged as a plurality of cells identified by cell id, each cell having a granularity of k individual memory addresses;
b) providing a packet descriptor list identifying a starting cell id of a packet selected for retrieval; and
c) providing a cell list indexed by cell id, the cell list including a selected packet list identifying a sequence of cells storing portions of the selected packet, the cell list including a free cell list identifying cells available for storing data, wherein the selected packet list and free cell list are each linked lists.

2. The method of claim 1 comprising:
d) retrieving each portion of the selected packet from the memory, wherein the portions are retrieved from the cells and in the sequence indicated by traversing the cell list beginning with the starting cell id.

3. The method of claim 1 further comprising:
d) modifying the cell list links to pre-pend the selected packet list to the free cell list after successfully retrieving the packet.

4. The method of claim 1 wherein d) further comprises:
i) modifying the cell list entry indexed by a last cell id of the retrieved packet to reference a beginning of the free cell list; and
ii) designating the cell list entry indexed by the starting cell id as the beginning of the free cell list after successfully retrieving the packet.

5. The method of claim 1 further comprising:
d) modifying the cell list links to append the selected packet list to the free cell list after successfully retrieving the packet.

6. The method of claim 5 wherein d) further comprises:
i) modifying the cell list entry indexed by an end of the free cell list to reference the starting cell id; and
ii) designating the cell list entry indexed by the last cell id of the retrieved packet as the end of the free cell list.

7. The method of claim 1 wherein the addresses are n bits long, wherein the cell id is m bits long, wherein the granularity k=2^{n-m}.

8. The method of claim 1 wherein the cell list has y+1 entries, wherein the index of each of at least y entries maps to a cell of the memory.

9. The method of claim 8 wherein the cell list has y+1 entries, wherein at least one index does not map to a cell of the memory.

10. An apparatus comprising:
a first memory arranged as a plurality of cells identified by cell id, each cell having a granularity of k individual memory addresses;
a second memory storing a packet descriptor list identifying a starting cell id of a packet selected for retrieval, the second memory storing a cell list indexed by cell id, the cell list including a selected packet list identifying a sequence of cells storing portions of the selected packet, the cell list including a free cell list identifying cells available for storing data, wherein the selected packet list and free cell list are each linked lists; and
an execution component managing the packet descriptor list, the cell list, and retrieval of the selected packet.

11. The apparatus of claim 10 wherein the execution component is one of a processor and a state machine.

12. The apparatus of claim 10 wherein the execution component retrieves each portion of the selected packet from the memory, wherein the portions are retrieved from the cells and in the sequence indicated by traversing the cell list beginning with the starting cell id.

13. The apparatus of claim 10 wherein the execution component modifies the cell list links to pre-pend the selected packet list to the free cell list after successfully retrieving the packet.

14. The apparatus of claim 10 wherein the execution component modifies the cell list links to append the selected packet list to the free cell list after successfully retrieving the packet.

15. The apparatus of claim 10 wherein the first memory and the second memory are different areas of a same memory.

16. A method comprising:
a) providing a memory arranged as a plurality of cells identified by cell id, each cell having a granularity of k individual memory addresses;
b) providing a cell list indexed by cell id, the cell list including a free cell list identifying cells available for storing data as a linked list, wherein a beginning of the free cell list identifies a starting cell id; and
c) storing each portion of a packet in cells indicated by and in a sequence indicated by traversing the cell list beginning with the starting cell id.

17. The method of claim 16 further comprising:
d) storing a packet descriptor in a packet descriptor list, wherein the packet descriptor indicates the starting cell id of the stored packet.

18. The method of claim 16 further comprising:
d) identifying the cell pointed to by the cell list entry indexed by the last cell id of the stored packet;
e) designating the identified cell as the beginning of the free cell list.

19. An apparatus comprising:
a first memory arranged as a plurality of cells identified by cell id, each cell having a granularity of k individual memory addresses;
a second memory storing a cell list indexed by cell id, the cell list including a free cell list identifying cells available for storing data as a linked list, wherein a beginning of the free cell list identifies a starting cell id; and
an execution component storing each portion of a packet in cells indicated by and in a sequence indicated by traversing the cell list beginning with the starting cell id.

20. The apparatus of claim 19 wherein the execution component is one of a processor and a state machine.

21. The apparatus of claim 19 wherein the execution component stores each portion of the selected packet in the memory, wherein the portions are stored in the cells and in the sequence indicated by traversing the cell list beginning with the starting cell id.
